(19) United States
(12) Patent Application Publication
(10) Pub. No.: US 2014/0074668 A1
(43) Pub. Date: Mar. 13, 2014

(54) Sensor-based Risk Assessment in Supply Chain Processes

(71) Applicant: Laurent Gomez, Le Cannet (FR)

(72) Inventor: Laurent Gomez, Le Cannet (FR)

(73) Assignee: SAP AG, Walldorf (DE)

(21) Appl. No.: 13/612,457

(22) Filed: Sep. 12, 2012

(51) Int. Cl. G06Q 10/08

(52) U.S. Cl. 705/28

(57) ABSTRACT

In one embodiment, a method includes determining a set of constraints based on a supply chain activity and a classification. The method then configures a set of sensor nodes based on the set of constraints. The set of sensor nodes is associated with an asset being monitored. A notification is received from a sensor node when one of the set of constraints is violated by a current context detected by the sensor node for the asset. The set of sensor nodes uses the set of constraints to evaluate the set of constraints against current contexts detected in the supply chain activity in real-time. The method then sends an alert to a supply chain management system based on the notification, the alert indicating the violation of the constraint associated with the asset.

### BACKGROUND

As a consequence of globalization, supply chain systems have evolved towards a dynamic network of companies and industries. The complexity of the supply chain processes raises several challenges in particular with respect to compliance with regulations, such as safety and security. The globalization of trade has been accompanied by a growth in the number of intermediate partners involved in the supply chain. These intermediate partners are mainly in charge of transportation and/or storage of goods. The increased use of the intermediate partners has increased the risk of disruption in the supply chain. For example, the supply of chemical substances raises risks of fire, explosion, or environmental pollution. To mitigate these risks, and prevent any serious impact on population safety, safety regulations are put in place. Intermediate partners in the supply chain must be compliant with these regulations, such as the regulations may regulate the handling, transport, and storage constraints on chemicals. However, even with the regulations, with the increase of intermediate partners, the chance a single non-compliant actor might be non-compliant increases, which jeopardizes the safety for the entire supply chain process.

To mitigate the occurrence of non-compliance during the supply chain process, some companies rely on human operators. For example, human operators may monitor conditions locally, such as in a warehouse or on a truck transporting the goods. However, using human operators is subject to human error, which risks disruption of regulation checks along the supply chain. Further, even when intermediate partners perform checks to determine violations of the regulations, information for possible violations remains local. That is, the entire supply chain is not notified of possible violations. For example, in the case when ambient temperature reaches a chemical flashpoint during transportation, a storage unit may receive the good without being informed of the inherent risk of explosion. In this case, the transportation company may have been concerned with the violation of the regulation during their action during the supply chain, but is not concerned about the non-compliance with other supply chain partners. In this case, the transportation company should have alerted the storage company of the possible violation. For example, the transportation company should have warned the storage company there is a risk of explosion of the good because the good had been exposed to a high temperature during transportation. In this case, the risk of explosion during storage may remain for a certain time period until the temperature of the product goes back to normal.

### SUMMARY

In one embodiment, a method includes determining a set of constraints based on a supply chain activity and a classification. The method then configures a set of sensor nodes based on the set of constraints. The set of sensor nodes is associated with an asset being monitored. A notification is received from a sensor node when one of the set of constraints is violated by a current context detected by the sensor node for the asset. The set of sensor nodes uses the set of constraints to evaluate the set of constraints against current contexts detected in the supply chain activity in real-time. The method then sends an alert to a supply chain management system based on the notification, the alert indicating the violation of the constraint associated with the asset.

In one embodiment, a non-transitory computer-readable storage medium is provided that contains instructions, that when executed, control a computer system to be configured for: determining a set of constraints based on a supply chain activity and a classification; configuring a set of sensor nodes based on the set of constraints, the set of sensor nodes associated with an asset being monitored; receiving a notification from a sensor node when one of the set of constraints is violated by a current context detected by the sensor node for the asset, wherein the set of sensor nodes use the set of constraints to evaluate the set of constraints against current contexts detected in the supply chain activity in real-time; and sending an alert to a supply chain management system based on the notification, the alert indicating the violation of the constraint associated with the asset.

In one embodiment, an apparatus is provided comprising: one or more computer processors; and a non-transitory computer-readable storage medium comprising instructions, that when executed, control the one or more computer processors to be configured for: determining a set of constraints based on a supply chain activity and a classification; configuring a set of sensor nodes based on the set of constraints, the set of sensor nodes associated with an asset being monitored; receiving a notification from a sensor node when one of the set of constraints is violated by a current context detected by the sensor node for the asset, wherein the set of sensor nodes use the set of constraints to evaluate the set of constraints against current contexts detected in the supply chain activity in real-time; and sending an alert to a supply chain management system based on the notification, the alert indicating the violation of the constraint associated with the asset.

The following detailed description and accompanying drawings provide a better understanding of the nature and advantages of particular embodiments.

### BRIEF DESCRIPTION OF THE DRAWINGS

FIG. 1 depicts an example of a supply chain according to one embodiment.

FIG. 2 depicts a system for monitoring compliance with regulations throughout a supply chain process according to one embodiment.

FIG. 3 depicts a relationship of entities in the risk management according to one embodiment.

FIG. 4 depicts a method for performing risk assessment using sensor nodes according to one embodiment.

FIG. 5A shows an example of a monitoring constraint according to one embodiment.

FIG. 5B shows an example of an alert constraint according to one embodiment.

FIG. 5C shows an example of a combination of constraints according to one embodiment.

FIG. 6 depicts a more detailed example of a sensor management system according to one embodiment.

FIG. 7 depicts a simplified flowchart for configuring constraints on sensor nodes according to one embodiment.

FIG. 8 depicts a simplified flowchart for processing alerts according to one embodiment.

FIG. 9 illustrates hardware of a special purpose computing machine configured with sensor node risk assessment according to one embodiment.

### DETAILED DESCRIPTION

Described herein are techniques for a sensor-based risk assessment system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

Particular embodiments perform risk assessment using a network of sensor nodes that are attached to assets, such as products or goods, to perform automatic risk assessment along the supply chain. The sensor nodes may be automatically programmed with a set of constraints that the sensor nodes can use while monitoring current conditions. The sensor nodes can trigger an alert when constraints are violated based on current conditions along the supply chain. The alert may be forwarded to a supply chain management system where the supply chain management system may enforce compliance with regulations associated with the alert. In this case, the party in the supply chain associated with the violation may be alerted that a possible violation may be occurring. Additionally, the supply chain management system may alert other parties in the supply chain process of the violation.

### Supply Chain Processes

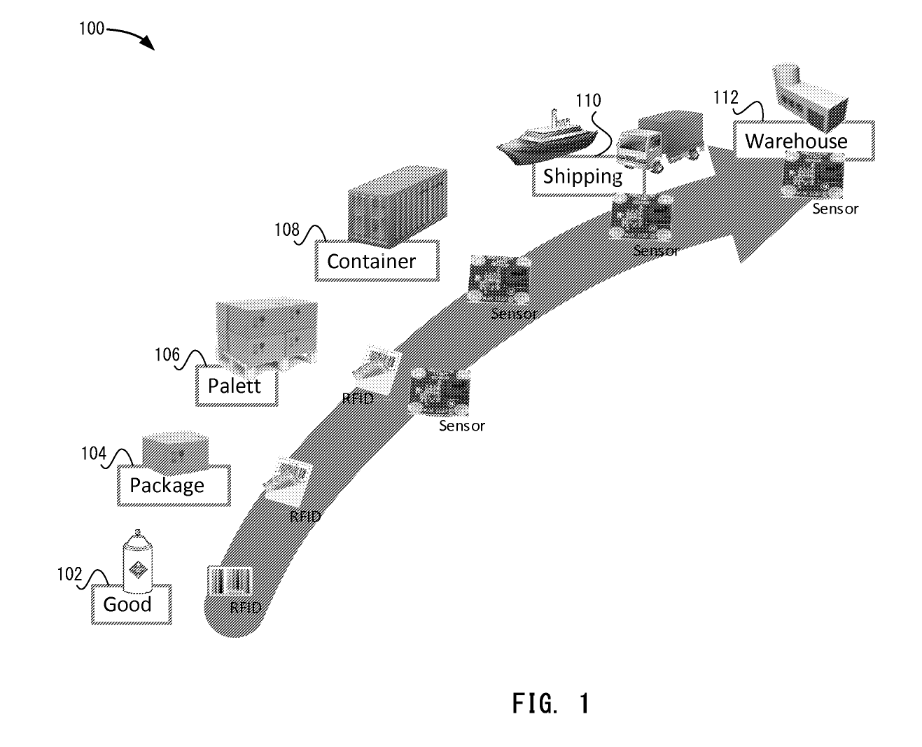

FIG. 1 depicts an example of a supply chain 100 according to one embodiment. In one example, at 102, an asset, such as a good may be manufactured by a company. Radio frequency identifiers (RFIDs) are used in product tracking for part of the supply chain. Additionally, sensor nodes may be used in conjunction with RFIDs or at different points of the supply chain. Depending on the asset, a sensor node may be used at a product level, on the packaging, or on the pallet. If the sensor node is on the product level, the sensor node may be attached to the actual product. If the sensor node is on the packaging level, the sensor node may be attached to the packaging of the asset. If the sensor node is on the pallet level, the sensor node may be on the pallet that may be carrying multiple packages for the asset. Additionally, an asset may include multiple sensors. Each sensor may monitor different environmental conditions.

RFIDs focus on the identification of products, e.g., identification and classification, and sensor nodes monitor and control the supply chain environment. RFIDs may also be associated with information related to a classification of the asset and/or the dangerousness of the asset. The classification may classify the asset in different categories. For example, different products are classified in different categories. Based on these classifications, regulations, e.g., safety or quality regulations, the handling, storage, and transportation constraints, may be identified. Sensor nodes then enforce these constraints (e.g., constraints associated with incompatibilities with other products, flashpoints, etc.).

As seen, the supply chain includes a good, package, pallet, container, shipping, and warehouse supply chain processes. Other supply chain processes may also be appreciated. Different supply chain parties manage different parts of the supply chain. In one example, at 102, 104, and 106, RFIDs may be used to identify an asset. Additionally, at 106, 108, 110, and 112, sensor nodes may be used to evaluate compliance with regulations. Although sensor nodes are described as being used in these supply chain processes, it will be understood that sensor nodes may be used in other supply chain processes.

### System Overview

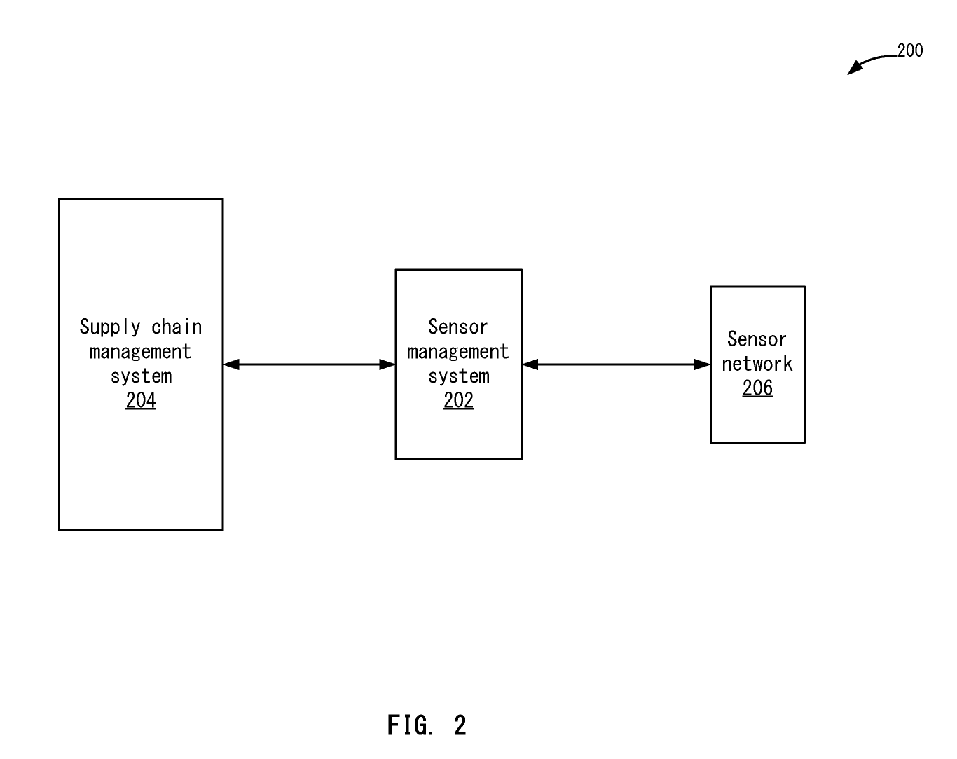

FIG. 2 depicts a system 200 for monitoring compliance with regulations throughout a supply chain process according to one embodiment. System 200 includes a sensor management system 202, a supply chain management system 204, and a sensor network 206. Supply chain management system 204 may include software that manages the supply chain process. For example, supply chain management system 204 may communicate with different actors in the supply chain.

Sensor management system 202 provides the coordination for configuring sensors, which may be wireless or wired sensors, in sensor network 206 to monitor constraints based on a context. For example, the context may include real-time environment information. Sensor management system 202 may receive alerts from sensor network 206 when certain constraints are violated. Sensor management system 202 may then alert supply chain management system 204 of the violations. Supply chain management system 204 may perform remedial actions based on the alert. For example, supply chain management system 204 may alert various intermediate partners in the supply chain of the violation. These partners may then use this information as the assets are being handled. For example, the partners may adjust their actions, such as the storage of the asset may be adjusted based on the violation that was detected by another partner in the supply chain.

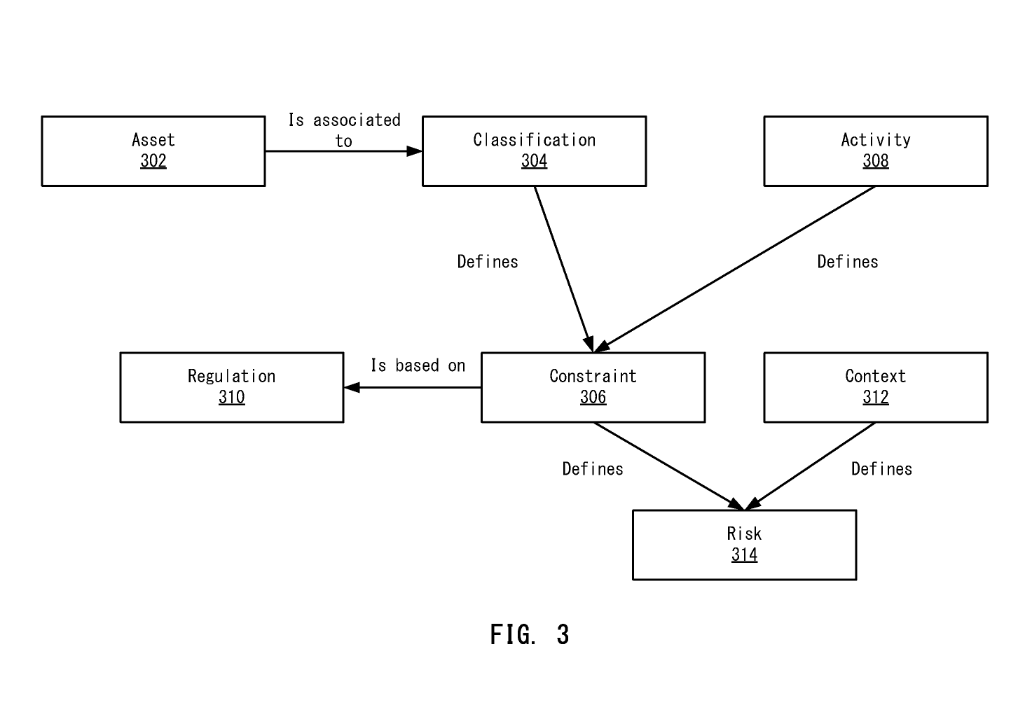

As discussed above, sensor nodes evaluate constraints to perform risk management. FIG. 3 depicts a relationship of entities in the risk management according to one embodiment. Supply chain management systems are in charge of the delivery of assets to final customers. Depending on the assets' classification, specific regulations define constraints along the supply chain based on the activity of the assets (e.g., storage, transportation, transformation, etc.). Regulations may thus vary from one activity to another. For example, a constraint on the stability of a storage rack may only be applicable in a storage location. The non-compliance with regulations may lead to risky situations. For example, considering the flashpoint of a chemical, the following constraint may be defined: The temperature must not exceed 13° Celsius. Whenever this constraint is violated, the risk of explosion is increased. Thus, a context associated with the constraint should be monitored. The context may be any kind of information that characterizes the environment of the asset.

In FIG. 3, at 302, an asset may be any product or merchandise manipulated along the supply chain towards the final customer. Assets may be characterized by a classification at 304. For example, the assets may be classified in different categories. At 306, a constraint may be a representation of regulations at 310 for a specific asset based on its classification. The constraint is also defined by an activity shown at 308 where the activity may be any steps in the supply chain from production to delivery to the final customer including transformation, loading on a pallet, truck transportation, or storage in a storage rack. For example, depending on what information the regulation includes, the constraint is developed, such as the constraint on the stability of a pallet containing chemicals is applicable during the storage activity.

At 312, a context may be any type of information characterizing an environment of the asset along the supply chain. For example, the context may be a temperature detected at a storage rack in a storage facility. At 314, a risk may be a probability that an incident occurs in the supply chain due to non-compliance with regulations. Additionally, a risk depends on a mismatch between the constraints on assets and their context in the supply chain. If a constraint on temperature is defined, the probability on the incident occurrence depends on a violation of the context of the asset.

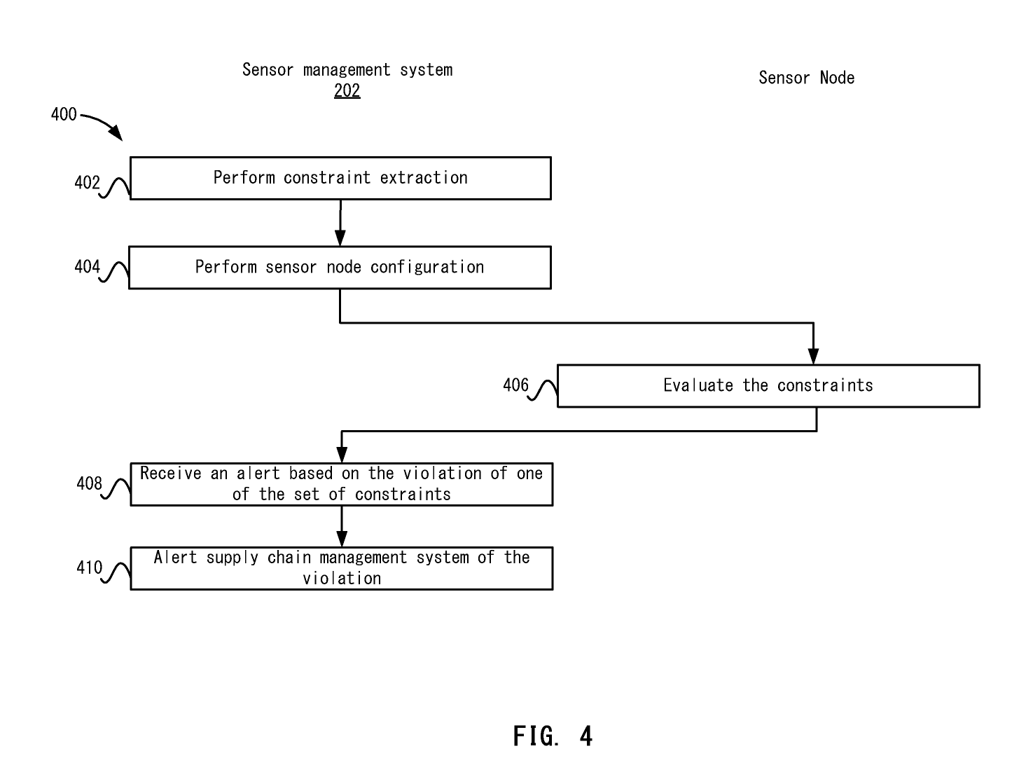

FIG. 4 depicts a method for performing risk assessment using sensor nodes according to one embodiment. At 402, sensor management system 202 performs constraint extraction. For constraint extraction, constraints over an asset classification and a supply chain activity are defined. In this case, sensor management system 202 may evaluate regulations (e.g., safety, quality, etc.) to extract a per-asset classification (e.g., chemicals, food, etc.) and a supply chain activity (e.g., transportation, storage, etc.) to determine a set of constraints. In one embodiment, sensor management system 202 performs the constraint extraction rather than each sensor node although sensor nodes may also perform these tasks.

At 404, sensor management system 202 performs sensor node configuration. For example, sensor management system 202 pushes the identified constraints to sensor nodes attached to assets. In one embodiment, sensor management system 202 may determine sensor nodes that are attached to assets and select one or more of the sensor nodes that can evaluate the constraints.

At 406, the sensor nodes may evaluate the constraints. For example, once the constraints have been configured on the sensor nodes, the sensor nodes evaluate in real time a current context based on the set of constraints. For example, the sensor nodes may evaluate the temperature against the set of constraints.

At 408, sensor management system 202 receives an alert based on the violation of one of the set of constraints. For example, sensor management system 202 receives an alert from a sensor node when one of the set of constraints is violated. At 410, sensor management system 202 alerts supply chain management system 204 of the violation. Supply chain management system 204 may then perform a remedial action, such as notifying other partners in the supply chain of the violation.

### Constrain Definition

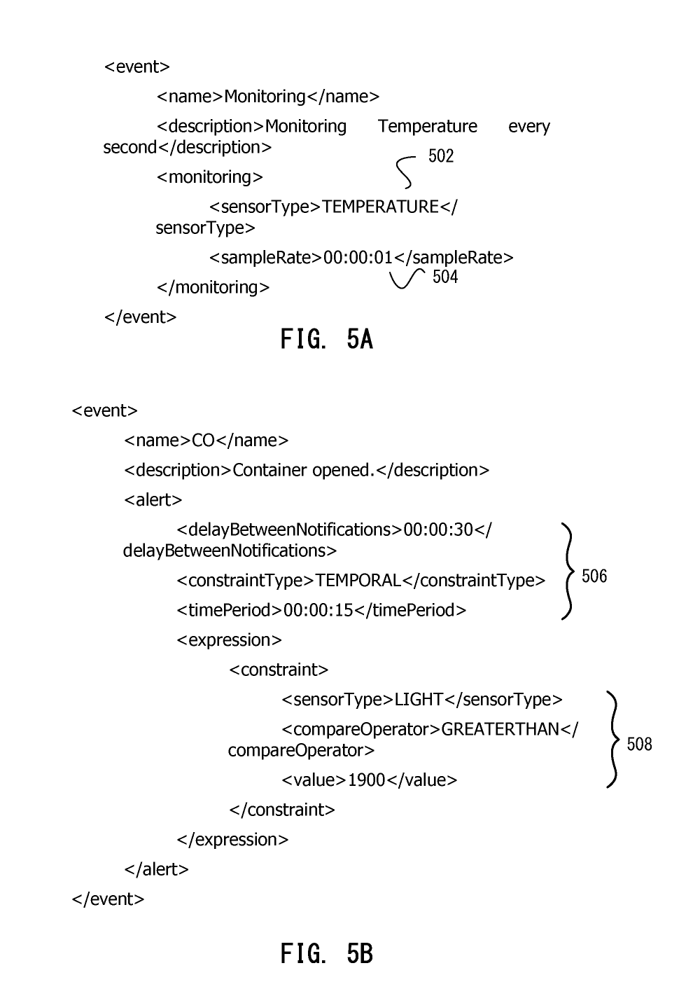

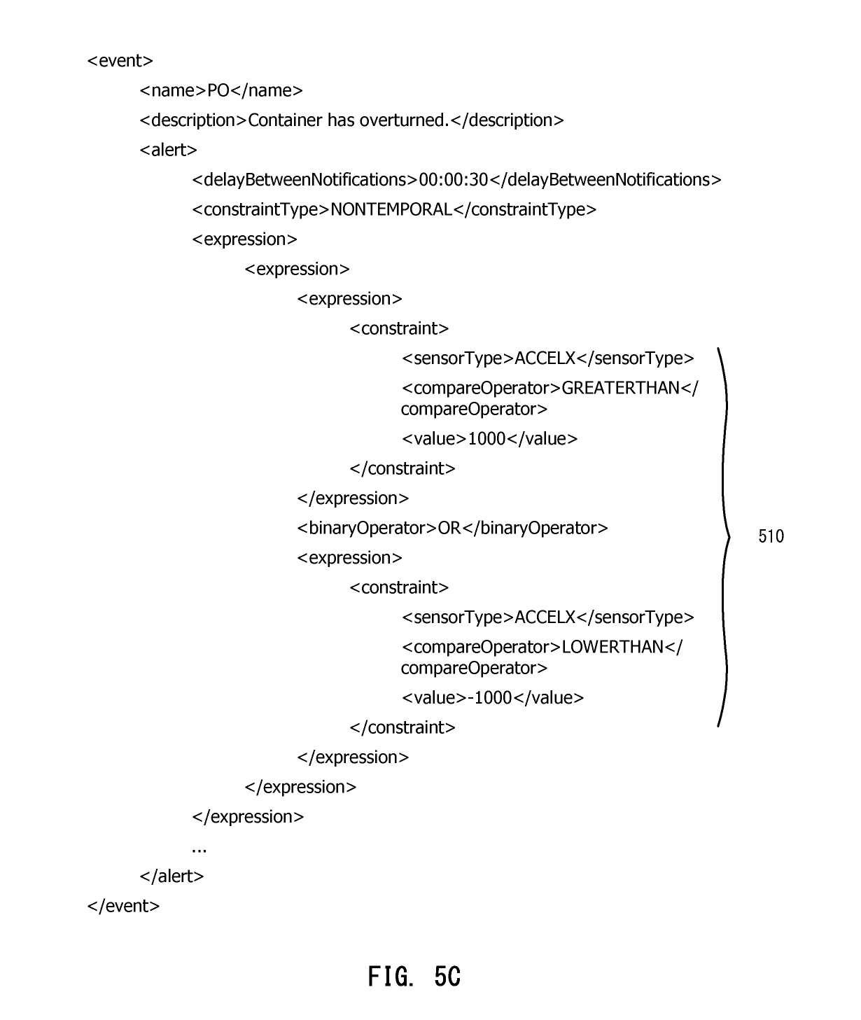

The constraints need to be defined in a format that can be processed by sensor nodes. FIGS. 5A, 5B, and 5C show examples of constraint definitions according to one embodiment. The set of constraints to be monitored depends on the asset's classification. For example, the constraints may be based on temperature, shock, and container overturning. In one example, constraints are extracted from a regulation and may be represented in a format, such as an extensible markup language (XML) format. The XML format is mapped to the asset's classification that is extracted from the regulations. In one embodiment, constraints may be of two types: monitoring and alerting constraints.

FIG. 5A shows an example of a monitoring constraint according to one embodiment. The monitoring constraint deals with the regular monitoring of a given type of information, such as temperature. As shown at 502, the sensor type is a temperature sensor. Also, at 504, the constraint indicates the type of monitoring, such as the sample rate.

FIG. 5B shows an example of an alert constraint according to one embodiment. An alert constraint may define a threshold over a given sensor data type. Whenever that threshold is reached, the sensor node may trigger an alert. Additionally, temporality may be defined on the alert, such as the sensor node triggers an alert is triggered only if the constraint is violated for a given time. For example, if the light is above a threshold for 15 seconds, the sensor node may trigger an alert. At 506, the temporal aspect of the constraint is defined. Also, at 508, the threshold is defined as the light being greater than a value of 1900.

FIG. 5C shows an example of a combination of constraints according to one embodiment. This combination of simple constraints enables abstract concepts to be monitored by a constraint on a sensor node. For example, the constraint in FIG. 5B shows that if the constraint is violated, the sensor node triggers an alert for container overturn. In FIG. 5C, the abstract constraint is based on acceleration monitoring. For example, at 510, the acceleration monitoring is defined to determine if the container has overturned.

### Constraint Evaluation on Sensor Nodes

Once sensor management system 202 has pushed the constraints to the sensor nodes, the sensor nodes evaluate the constraints. In one embodiment, the sensor nodes have restricted resources available. For example, processing of the XML for the constraints may be barely achievable. Thus, the constraint definition should have a low memory cost and be easily executable on the sensor node. In one embodiment, a set of constraints may be represented on the sensor node with a set of simple constraints and a byte code. The set of simple constraints may follow the template of [SensorType] [Operator] [Value] [TypeofConstraints] [iTemporalValue] (e.g., A=alert if temperature greater than 20; B=alert if tilt lower than 50 for more than 5 seconds). A byte code describes the execution of the simple constraints. For example, the byte code may use reverse Polish notation (RPN) where each operator follows their operands. (e.g., if A and B are a simple constraint, the evaluation of A and B will be written as “A B AND”). The interpretation may be stack-based; that is, operands are pushed onto a stack and when an operation is performed, its operands are popped from a stack and its results pushed back on. In the byte code, sensor nodes may support three operands of AND, OR, and NOT. Other operands may also be supported.

In real time, the sensor node collects all available ambient information (e.g., noise, temperature, etc.). The sensor node then evaluates each simple constraint and executes the loaded byte code. If a violation in the combination of the simple constraint is identified, the sensor node sends an alert to sensor management system 202.

### Architecture

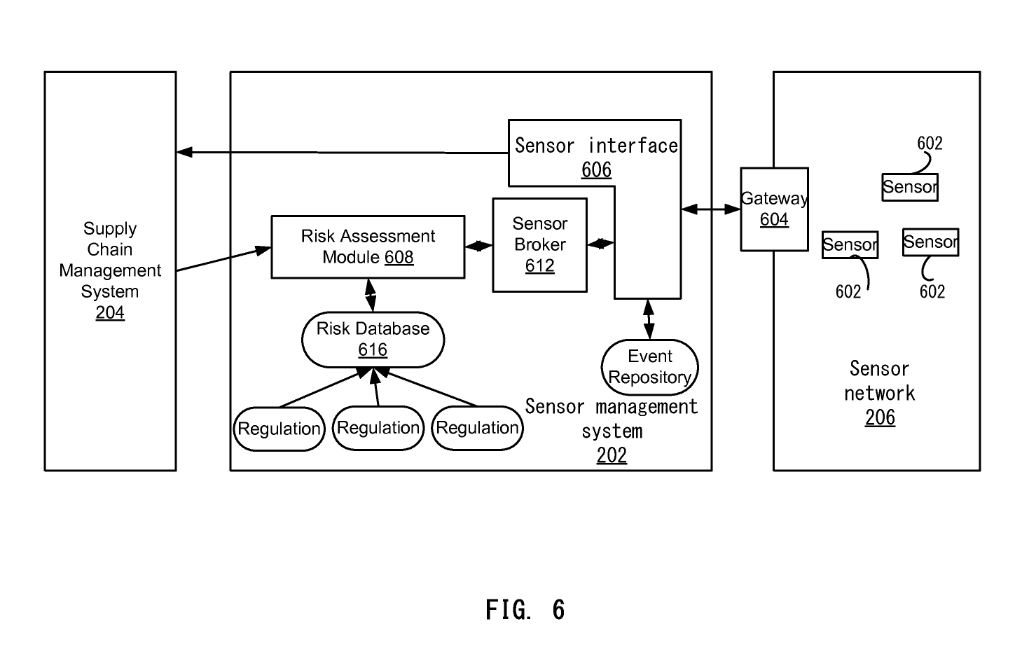

FIG. 6 depicts a more detailed example of sensor management system 202 according to one embodiment. As discussed above, supply chain management system 204 monitors assets along the execution of the supply chain. For example, supply chain management system 204 receives alerts in case of any incident that may disrupt the supply chain process.

Also, sensor network 206 may include a plurality of sensor nodes 602. Multiple sensor nodes 602 may be attached to assets. Additionally, sensor nodes 602 may be attached to other levels, such as the pallet level. Sensor nodes 602 may communicate wirelessly through a gateway 604 to sensor management system 202, such as through a wide area network (WAN).

A risk assessment module 608 receives subscriptions for asset monitoring from supply chain management system 204. For example, supply chain management system 204 may want to monitor specific assets and sends subscriptions for the monitoring to risk assessment module 608. The subscriptions may also include a classification of the assets.

Risk assessment module 608 extracts different constraints to be evaluated on sensor nodes 602 from a risk database 610. Risk database 610 may be connected to different regulatory repositories to extract the constraints.

A sensor broker 612 may be in charge of selecting appropriate sensor nodes 602 to monitor the asset. For example, sensor broker 612 determines which sensor nodes 602 are available for the asset. Sensor broker 612 then identifies a sensor node 602 that is able to evaluate the constraints. For example, if temperature alerting is required by a constraint, a selected sensor node 602 has to support monitoring temperature.

Sensor interface 606 then pushes the constraints through gateway 604 to the selected sensor node 602. Also, sensor interface 606 may receive alerts from sensor nodes 602. Sensor interface 606 then forwards the alerts to supply chain management system 204.

### Constraint Configuration Method Flow

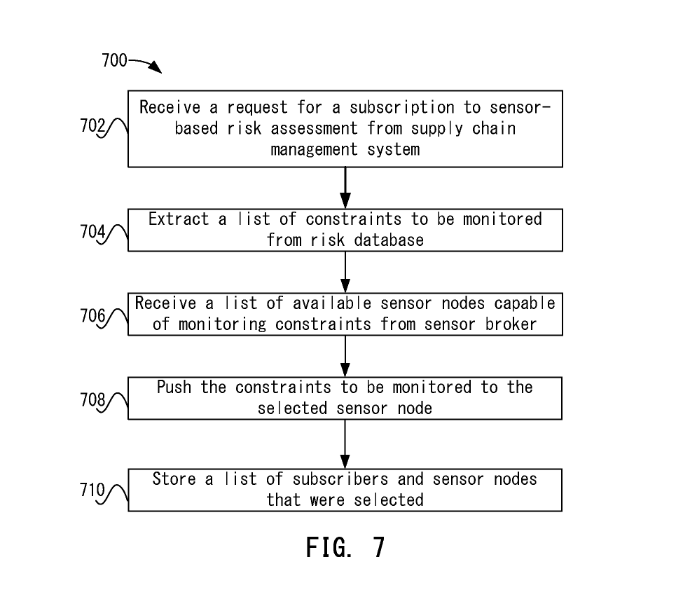

FIG. 7 depicts a simplified flowchart for configuring constraints on sensor nodes 602 according to one embodiment. At 702, sensor management system 202 receives a request for a subscription to sensor-based risk assessment from supply chain management system 204. In one embodiment, supply chain management system 204 includes a unique identifier of the asset (product/good) to be monitored, the asset's classification, and the endpoint of the subscriber. The unique identifier uniquely identifies the asset. In one embodiment, the unique identifier may identify a specific asset, such as one package for a good. In other embodiments, the unique identifier may identify a group of packages. The endpoint of the subscriber will be used later for notification of alerts to the subscribing supply chain management system 204.

At 704, risk assessment module 608 extracts a list of constraints to be monitored from risk database 610. Risk database 610 includes a description of constraints to be monitored on a per asset classification basis. Risk assessment module 608 extracts these constraints.

At 706, risk assessment module 608 receives a list of available sensor nodes 602 capable of monitoring those constraints from sensor broker 612. For example, if a classification defines constraints for temperature, a sensor node 602 that can monitor temperature needs to be selected. Sensor broker 612 then determines which sensor nodes 602 have been attached to the asset (or package or pallet). At 708, risk assessment module 608 selects an available sensor node 602.

At 710, sensor interface 606 pushes the constraints to be monitored to the selected sensor node 602. In one embodiment, sensor interface 606 may transform the constraints into a sensor-specific native code. For example, different sensor nodes 602 may be configured to process different native code. The native code defines a set of instructions to be executed on sensor nodes 602 to evaluate any violation of constraints. The XML code described about may be used in one embodiment.

At 712, sensor interface 606 stores a list of subscribers and sensor nodes that were selected. This list is used whenever an alert is triggered by a sensor node 602. For example, when an alert is triggered by a sensor node identified by a sensor node identifier, sensor interface 606 looks up the subscriber that subscribes to that alert, and sends the alert to the subscriber.

### Alert Processing Method Flow

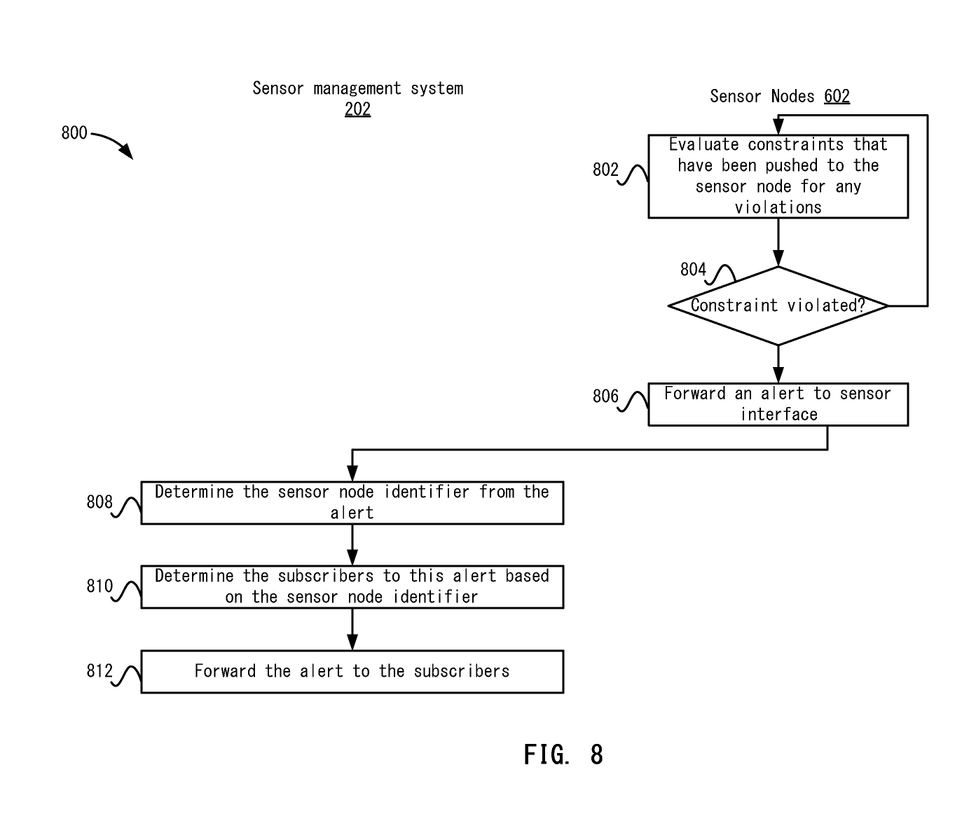

FIG. 8 depicts a simplified flowchart 800 for processing alerts according to one embodiment. At 802, sensor nodes 602 evaluate constraints that have been pushed to the sensor node for any violations. At 804, sensor node 602 determines if a constraint has been violated. If not, the process reiterates to continue to evaluate real time conditions.

At 806, if a violation has occurred, sensor node 602 forwards an alert to sensor interface 606. At 808, sensor interface 606 determines the sensor node identifier from the alert. At 810, sensor interface 606 determines the subscribers to this alert based on the sensor node identifier. At 812, sensor interface 606 then forwards the alert to the subscribers.

Although supply chain management has been described, different business domains may also use the sensor node monitoring. For example, remote patient monitoring, herd monitoring, surveillance of critical infrastructure, etc. may use the risk assessment using sensor nodes. Any of these could use the real-time constraint evaluation along any of the parties of the business process and also the real-time notification in case of violation of some of the constraints.

### System Example

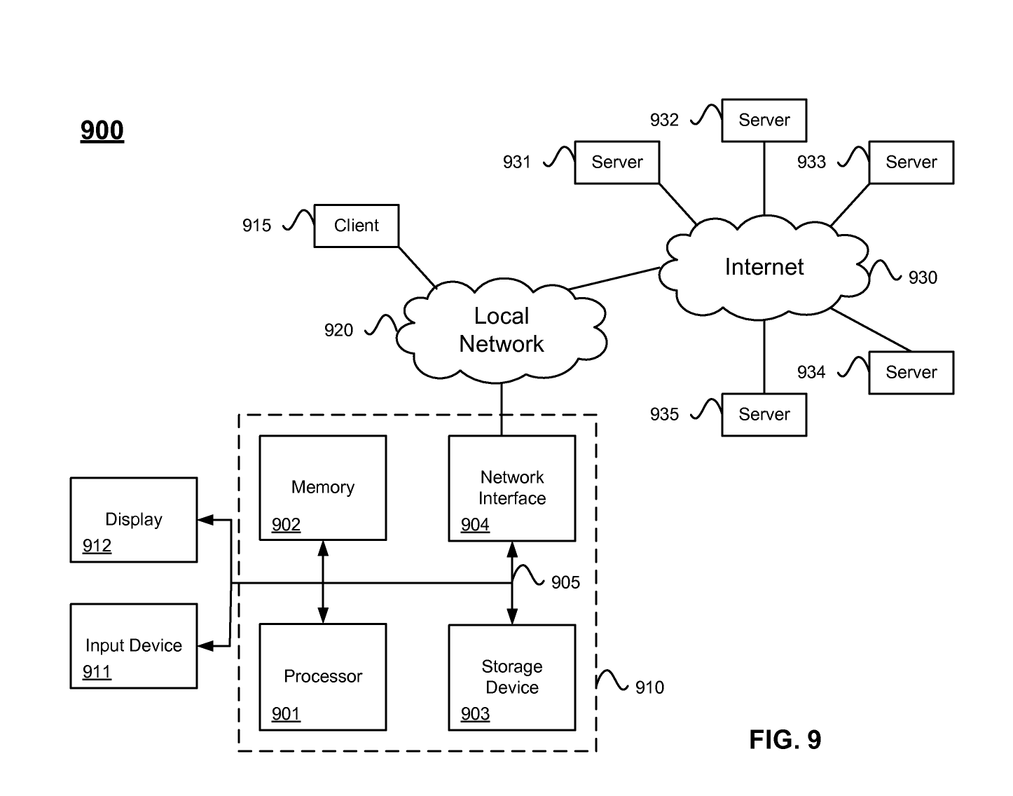

FIG. 9 illustrates hardware of a special purpose computing machine configured with sensor node risk assessment according to one embodiment. An example computer system 910 is illustrated in FIG. 9. Computer system 910 includes a bus 905 or other communication mechanism for communicating information, and a processor 901 coupled with bus 905 for processing information. Computer system 910 also includes a memory 902 coupled to bus 905 for storing information and instructions to be executed by processor 901, including information and instructions for performing the techniques described above, for example. This memory may also be used for storing variables or other intermediate information during execution of instructions to be executed by processor 901. Possible implementations of this memory may be, but are not limited to, random access memory (RAM), read only memory (ROM), or both. A storage device 903 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 903 may include source code, binary code, or software files for performing the techniques above, for example. Storage device and memory are both examples of computer readable storage mediums.

Computer system 910 may be coupled via bus 905 to a display 912, such as a cathode ray tube (CRT) or liquid crystal display (LCD), for displaying information to a computer user. An input device 911 such as a keyboard and/or mouse is coupled to bus 905 for communicating information and command selections from the user to processor 901. The combination of these components allows the user to communicate with the system. In some systems, bus 905 may be divided into multiple specialized buses.

Computer system 910 also includes a network interface 904 coupled with bus 905. Network interface 904 may provide two-way data communication between computer system 910 and the local network 920. The network interface 904 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 904 sends and receives electrical, electromagnetic, or optical signals that carry digital data streams representing various types of information.

Computer system 910 can send and receive information through the network interface 904 across a local network 920, an Intranet, or the Internet 930. In the Internet example, software components or services may reside on multiple different computer systems 910 or servers 931-935 across the network. The processes described above may be implemented on one or more servers, for example. A server 931 may transmit actions or messages from one component, through Internet 930, local network 920, and network interface 904 to a component on computer system 910. The software components and processes described above may be implemented on any computer system and send and/or receive information across a network, for example.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

1. A method comprising:
determining an asset and a classification associated with the asset to monitor;
determining a constraint based on a supply chain activity and the classification associated with the asset, wherein the constraint is evaluated against a context to determine when the constraint is violated;
determining a constraint definition for the constraint, the constraint definition including information needed by a sensor node to evaluate the constraint;
pushing, by a computing device, the constraint definition to the sensor node associated with the asset to configure the sensor node to evaluate the constraint, wherein the sensor node executes code determined from the constraint definition to evaluate the constraint against current contexts detected in a supply chain activity in real-time;
receiving, by the computing device, a notification from the sensor node when the constraint is violated by a current context detected by the sensor node for the asset, wherein the sensor node evaluated the constraint against the current context; and
sending, by the computing device, an alert to a supply chain management system based on the notification, the alert indicating the violation of the constraint associated with the asset.

2. The method of claim 1, wherein the constraint includes a monitoring constraint defining what information to monitor or an alerting constraint defining when to trigger the notification based on the information being monitored.

3. (canceled)

4. The method of claim 1, further comprising selecting the sensor node based on the constraint.

5. The method of claim 4, wherein selecting comprises:
determining available sensor nodes associated with the asset; and
determining which available sensor nodes associated with the asset are able to evaluate contexts associated with the constraint; and
selecting the sensor node from the available sensor nodes that are able to evaluate the contexts associated with the constraint.

6. The method of claim 1, wherein configuring comprises communicating the constraint definition through a network to the sensor node.

7. The method of claim 1, further comprising receiving a request from a subscriber for the supply chain management system for risk assessment for the asset.

8. The method of claim 7, further comprising:
storing a subscriber identifier for the subscriber that sent the request in association with the sensor node;
associating the subscriber identifier with the notification based on receiving the notification from the sensor node and the storing of the subscriber identifier in association with the sensor node; and
sending the alert to the subscriber associated with the subscriber identifier.

9. The method of claim 1, wherein the supply chain management system communicates with a partner in the supply chain to notify the partner of the violation of the constraint.

10. A non-transitory computer-readable storage medium containing instructions, that when executed, control a computer system to be configured for:
determining an asset and a classification associated with the asset to monitor;
determining a constraint based on a supply chain activity and the classification associated with the asset, wherein the constraint is evaluated against a context to determine when the constraint is violated;
determining a constraint definition for the constraint, the constraint definition including information needed by a sensor node to evaluate the constraint;
pushing the constraint definition to the sensor node associated with the asset to configure the sensor node to evaluate the constraint, wherein the sensor node executes code determined from the constraint definition to evaluate the constraint against current contexts detected in a supply chain activity in real-time;
receiving a notification from the sensor node when the constraint is violated by a current context detected by the sensor node for the asset, wherein the sensor node evaluated the one of constraint against the current context; and
sending an alert to a supply chain management system based on the notification, the alert indicating the violation of the constraint associated with the asset.

11. The non-transitory computer-readable storage medium of claim 10, wherein the constraint includes a monitoring constraint defining what information to monitor or an alerting constraint defining when to trigger the notification based on the information being monitored.

12. (canceled)

13. The non-transitory computer-readable storage medium of claim 10, further configured for selecting the sensor node based on the constraint.

14. The non-transitory computer-readable storage medium of claim 13, wherein selecting comprises:
determining available sensor nodes associated with the asset; and
determining which available sensor nodes associated with the asset are able to evaluate contexts associated with the constraint; and
selecting the sensor node from the available sensor nodes that are able to evaluate the contexts associated with the constraint.

15. The non-transitory computer-readable storage medium of claim 10, wherein configuring comprises communicating the constraint definition through a network to the sensor node.

16. The non-transitory computer-readable storage medium of claim 10, further configured for receiving a request from a subscriber for the supply chain management system for risk assessment for the asset.

17. The non-transitory computer-readable storage medium of claim 16, further configured for:
storing a subscriber identifier for the subscriber that sent the request in association with the sensor node;
associating the subscriber identifier with the notification based on receiving the notification from the sensor node and the storing of the subscriber identifier in association with the sensor node; and
sending the alert to the subscriber associated with the subscriber identifier.

18. The non-transitory computer-readable storage medium of claim 10, wherein the supply chain management system communicates with a partner in the supply chain to notify the partner of the violation of the constraint.

19. An apparatus comprising:
one or more computer processors; and
a non-transitory computer-readable storage medium comprising instructions, that when executed, control the one or more computer processors to be configured for:
determining an asset and a classification associated with the asset to monitor;
determining a constraint based on a supply chain activity and the classification associated with the asset, wherein the constraint is evaluated against a context to determine when the constraint is violated;
determining a constraint definition for the constraint, the constraint definition including information needed by a sensor node to evaluate the constraint;
pushing the constraint definition to the sensor node associated with the asset to configure the sensor node to evaluate the constraint, wherein the sensor node executes code determined from the constraint definition to evaluate the constraint against current contexts detected in a supply chain activity in real-time;
receiving a notification from the sensor node when the constraint is violated by a current context detected by the sensor node for the asset, wherein the sensor node evaluated the constraint against the current context; and
sending an alert to a supply chain management system based on the notification, the alert indicating the violation of the constraint associated with the asset.

20. The apparatus of claim 19, wherein the constraint includes a monitoring constraint defining what information to monitor or an alerting constraint defining when to trigger the notification based on the information being monitored.

21. The method of claim 1, wherein:
the constraint definition comprises one or more simple constraints and an execution code, and
the sensor node uses the execution code to evaluate the one or more simple constraints.

22. The method of claim 21, wherein the sensor node executes code by:
determining the current context for the one or more simple constraints, and
executing the execution code using the current context for the one or more simple constraints to determine whether the constraint is violated.

23. The method of claim 1, wherein the constraint definition includes the code executed by the sensor node.
